(19) United States
(12) Patent Application Publication
(10) Pub. No.: US 2025/0037683 A1
(43) Pub. Date: Jan. 30, 2025

(54) DPU DRIVEN ADAPTIVE SYNC FOR COMMAND MODE PANELS

(71) Applicant: QUALCOMM Incorporated, San Diego, CA (US)

(72) Inventors: Padmanabhan KOMANDURU V, Hyderabad (IN); Dileep MARCHYA, Hyderabad (IN); Srinivas PULLAKAVI, Kakinada (IN)

(21) Appl. No.: 18/709,469

(22) PCT Filed: Jan. 5, 2023
(86) PCT No.: PCT/US2023/010244

§ 371 Date: May 10, 2024

(30) Foreign Application Priority Data
Jan. 12, 2022 (IN) 202221001755

(51) Int. Cl. G09G 5/395; G09G 5/12; G09G 5/18

(52) U.S. Cl. CPC G09G 5/395; G09G 5/12; G09G 5/18

(57) ABSTRACT

This disclosure provides systems, devices, apparatus, and methods, including computer programs encoded on storage media, for DPU driven adaptive synchronization for command mode displays. A display processor may obtain one or more frame content buffers for a frame composition cycle. The display processor may obtain a fence for the one or more frame content buffers. The display processor may receive a signal for the fence for the one or more frame content buffers. The display processor may compose a first frame associated with the one or more frame content buffers for the frame composition cycle. The display processor may transfer, to a display memory of a display, data for the first frame associated with a first synchronization signal. The data for the first frame may be transferred at a default transfer rate or a boosted transfer rate.

### CROSS-REFERENCE TO RELATED APPLICATION

This application claims the benefit of Indian patent application Ser. No. 20/222,1001755, entitled “DPU DRIVEN ADAPTIVE SYNC FOR COMMAND MODE PANELS” and filed on Jan. 12, 2022, which is expressly incorporated by reference herein in its entirety.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display for displaying the visual content. A device that provides content for visual presentation on a display may utilize a CPU, a GPU, and/or a display processor.

Current techniques may not address adaptive synchronization for command mode displays. There is a need for a technique that enables adaptive synchronization for command mode displays.

### INTRODUCTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to obtain one or more frame content buffers for a frame composition cycle. The apparatus may be configured to obtain a fence for the one or more frame content buffers. The fence for the one or more frame content buffers may correspond to the frame content buffer being rendered. The apparatus may be configured to receive a signal for the fence for the one or more frame content buffers. The signal for the fence for the one or more frame content buffers may correspond to a frame associated with the fence being finished rendering. The apparatus may be configured to compose, based on the signal for the fence for the one or more frame content buffers, a first frame associated with the one or more frame content buffers for the frame composition cycle. The apparatus may be configured to transfer, to a display memory of a display, data for the first frame associated with a first synchronization signal. The data for the first frame may be transferred at a default transfer rate or a boosted transfer rate based on whether or not the data for the first frame is ready for the transfer prior to or at the first synchronization signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 is a block diagram that illustrates an example display framework in accordance with one or more techniques of this disclosure.

FIG. 3 is a diagram illustrating operation of adaptive synchronization in accordance with one or more techniques of this disclosure.

FIG. 4 is a diagram illustrating display timelines associated with a command mode display without adaptive synchronization in accordance with one or more techniques of this disclosure.

FIG. 5 is a call flow diagram illustrating example communications between a GPU, a DPU, and a display in accordance with one or more techniques of this disclosure.

FIGS. 6A and 6B are diagrams illustrating tear check models in accordance with one or more techniques of this disclosure.

FIG. 7 is a diagram illustrating display timelines associated with a command mode display with DPU driven adaptive synchronization in accordance with one or more techniques of this disclosure.

FIG. 8 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Adaptive synchronization technology may help to synchronize the display refresh with the GPU render rate to accommodate rendering delays at the GPU, thereby delivering a smoother user experience. A display working in the video mode may be referred to hereinafter as a video mode display. A display working in the command mode may be referred to hereinafter as a command mode display. The video mode may be similar to a conventional red-green-blue (RGB) interface. In particular, in the video mode, the host (e.g., the display processor) may periodically refresh the display based on the vertical synchronization (Vsync) signal. Because the host may refresh the display periodically, the display may not need a frame buffer. In contrast, in the command mode, the host may send a pixel data stream to the display using the display command set packets. The command mode display may include a full frame buffer to store all the received pixel data. Once the data is in the frame buffer of the command mode display, a timing controller of the command mode display may autonomously fetch the data from the frame buffer and render the data on the display. Accordingly, the host may not refresh the command mode display. One technique for enabling adaptive synchronization for video mode displays may include deferring the generation of the Vsync signal at the display processor (e.g., a display processing unit (DPU)) when a GPU rendering delay is encountered. As a result, the display refresh at the video mode display may be deferred as well, so that the delayed GPU rendering may be accommodated, and no frame miss may occur. However, because the display processor may not defer the display refresh at a command mode display as the refresh is controlled by the internal timing controller at the command mode display, this technique may not be applicable to command mode displays. A technique that may enable adaptive synchronization for command mode displays without modification to the command mode displays may be desirable.

According to one or more aspects of the disclosure, the compositor wake-up timeline and the DPU Vsync signals may be advanced by an offset relative to the tear effect (TE) signals provided by the command mode display to provide a margin to accommodate GPU rendering delays. When a GPU rendering delay occurs, the DPU may boost (increase) the clock frequency and the bandwidth for data transfer (in synchronous digital communication, the bandwidth may increase proportionately as the clock frequency increases) so that the data for the frame associated with the delayed GPU rendering may be transferred from the DPU to the display memory at a boosted rate in order to compensate for the delay in starting the data transfer caused by the GPU rendering delay. In different configurations herein, a DPU may refer to a display processor of any type (e.g., a dedicated DPU, a CPU, or a GPU performing display processing functions).

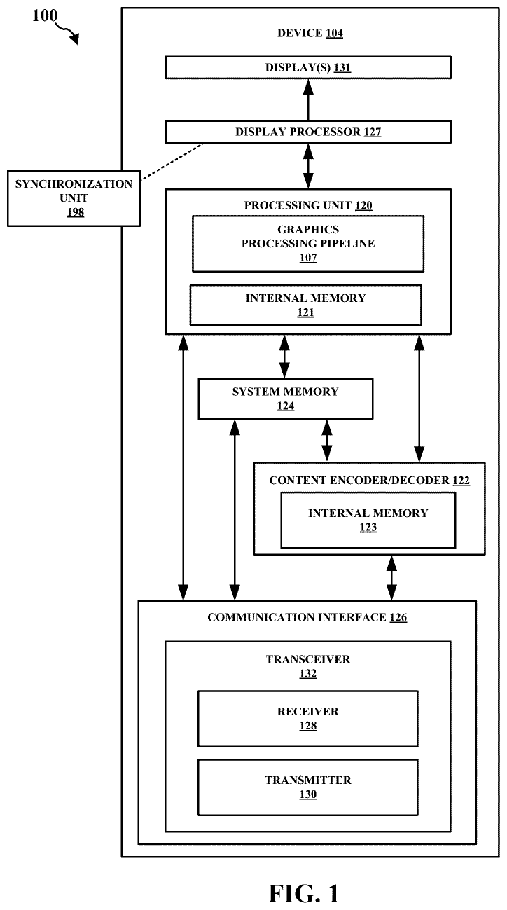

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of optional components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include an communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a synchronization unit 198 configured to obtain one or more frame content buffers for a frame composition cycle. The synchronization unit 198 may be configured to obtain a fence for the one or more frame content buffers. The fence for the one or more frame content buffers may correspond to the frame content buffer being rendered. The synchronization unit 198 may be configured to receive a signal for the fence for the one or more frame content buffers. The signal for the fence for the one or more frame content buffers may correspond to a frame associated with the fence being finished rendering. The synchronization unit 198 may be configured to compose, based on the signal for the fence for the one or more frame content buffers, a first frame associated with the one or more frame content buffers for the frame composition cycle. The synchronization unit 198 may be configured to transfer, to a display memory of a display, data for the first frame associated with a first synchronization signal. The data for the first frame may be transferred at a default transfer rate or a boosted transfer rate based on whether or not the data for the first frame is ready for the transfer prior to or at the first synchronization signal. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

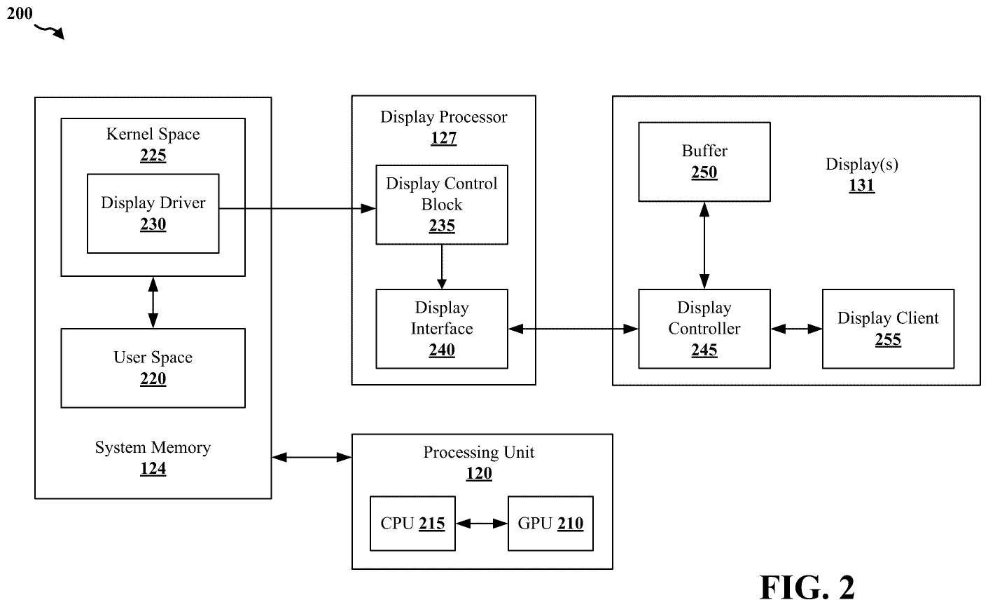

FIG. 2 is a block diagram 200 that illustrates an example display framework including the processing unit 120, the system memory 124, the display processor 127, and the display(s) 131, as may be identified in connection with the exemplary device 104.

A GPU is generally included in devices that provide content for visual presentation on a display. For example, the processing unit 120 may include a GPU 210 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 210 may be controlled based on one or more graphics processing commands provided by a CPU 215. The CPU 215 may be configured to execute multiple applications concurrently. In some cases, each of the concurrently executed multiple applications may utilize the GPU 210 simultaneously. Processing techniques may be performed via the processing unit 120 output a frame over physical or wireless communication channels.

The system memory 124, which may be executed by the processing unit 120, may include a user space 220 and a kernel space 225. The user space 220 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 225 may further include a display driver 230. The display driver 230 may be configured to control the display processor 127. For example, the display driver 230 may cause the display processor 127 to compose a frame and transmit the data for the frame to a display.

The display processor 127 includes a display control block 235 and a display interface 240. The display processor 127 may be configured to manipulate functions of the display(s) 131 (e.g., based on an input received from the display driver 230). The display control block 235 may be further configured to output image frames to the display(s) 131 via the display interface 240. In some examples, the display control block 235 may additionally or alternatively perform post-processing of image data provided based on execution of the system memory 124 by the processing unit 120. The display interface 240 may be configured to cause the display(s) 131 to display image frames. The display interface 240 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 250.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 250. For example, when a Vsync pulse is generated, the display processor 127 may output new graphical content to the buffer 250. Thus, generation of the Vsync pulse may indicate that current graphical content has been rendered at the buffer 250.

Frames are displayed at the display(s) 131 based on a display controller 245, a display client 255, and the buffer 250. The display controller 245 may receive image data from the display interface 240 and store the received image data in the buffer 250. In some examples, the display controller 245 may output the image data stored in the buffer 250 to the display client 255. Thus, the buffer 250 may represent a local memory to the display(s) 131. In some examples, the display controller 245 may output the image data received from the display interface 240 directly to the display client 255.

The display client 255 may be associated with a touch panel that senses interactions between a user and the display(s) 131. As the user interacts with the display(s) 131, one or more sensors in the touch panel may output signals to the display controller 245 that indicate which of the one or more sensors have sensor activity, a duration of the sensor activity, an applied pressure to the one or more sensor, etc. The display controller 245 may use the sensor outputs to determine a manner in which the user has interacted with the display(s) 131. The display(s) 131 may be further associated with/include other devices, such as a camera, a microphone, and/or a speaker, that operate in connection with the display client 255.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 210 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame. In some examples, the display control block 235 may be configured to obtain one or more frame content buffers for a frame composition cycle. The display control block 235 may be configured to obtain a fence for the one or more frame content buffers. The fence for the one or more frame content buffers may correspond to the frame content buffer being rendered. The display control block 235 may be configured to receive a signal for the fence for the one or more frame content buffers. The signal for the fence for the one or more frame content buffers may correspond to a frame associated with the fence being finished rendering. The display control block 235 may be configured to compose, based on the signal for the fence for the one or more frame content buffers, a first frame associated with the one or more frame content buffers for the frame composition cycle. The display control block 235 may be configured to transfer, via the display interface 240 to a display memory of a display 131, data for the first frame associated with a first synchronization signal. The data for the first frame may be transferred at a default transfer rate or a boosted transfer rate based on whether or not the data for the first frame is ready for the transfer prior to or at the first synchronization signal.

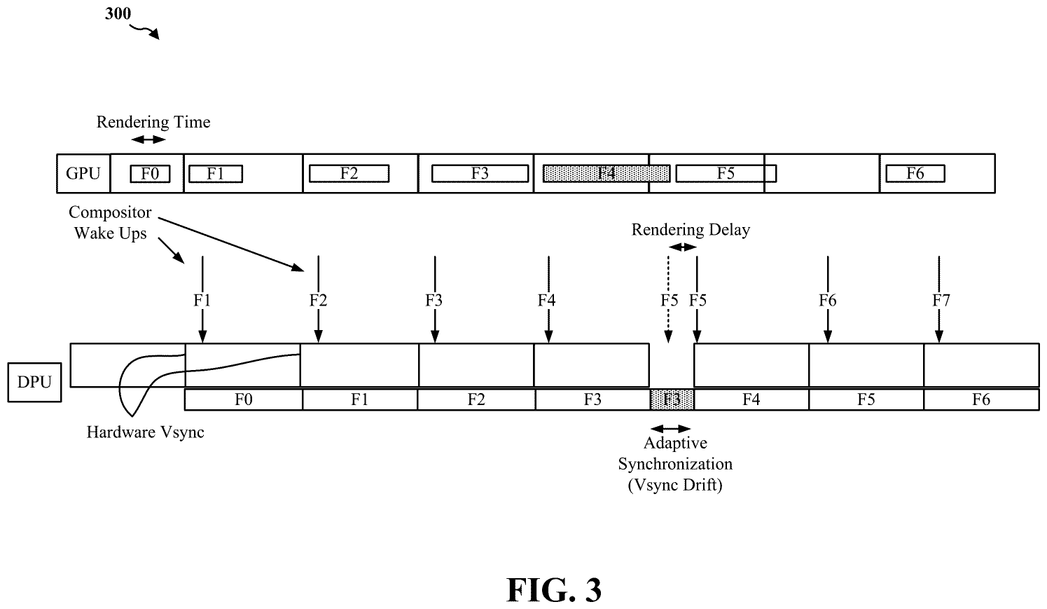

FIG. 3 is a diagram 300 illustrating the operation of adaptive synchronization in display processing. The adaptive synchronization technology may help to synchronize the display refresh rate with the GPU render rate to accommodate rendering delays at the GPU, thereby delivering a smoother user experience compared to devices that do not utilize adaptive synchronization. As illustrated in FIG. 3, a DPU that supports adaptive synchronization and a video mode display may be used. Compositor wake ups may be reference points for the display software to start and process the frame composition to the DPU hardware for the corresponding draw cycle. The DPU may generate periodic Vsync signals. Each Vsync period may correspond to one frame. If the GPU is able to complete the rendering associated with the frame content buffers for one frame on time (i.e., ahead of a threshold time associated with the frame), the DPU may compose the frame (at the direction of a compositor program run on the CPU), and may transmit the data for the frame to the display memory (also referred to as the display buffer) of the display based on the Vsync periodicity. On the other hand, if the GPU is not able to complete the rendering associated with the frame content buffers for one frame on time (i.e., the rendering is delayed beyond the threshold time associated with the frame), as is the case with frame 4 (F4) illustrated in FIG. 3, based on adaptive synchronization, the DPU may defer the generation of the Vsync signal for the frame until after the GPU has completed the rendering. This delay of the Vsync signal may be referred to as Vsync drift. Accordingly, the video mode display may continue to display the previous frame (e.g., F3) during the Vsync drift period. The DPU may resume the normal Vsync periodicity once the GPU is able to complete rendering subsequent frames on time (i.e., ahead of a threshold time associated with the frame).

The GPU rendering delays may be more evident on high refresh rate (e.g., 120 Hz, 140 Hz, or above) displays due to tighter timing thresholds compared to displays with lower refresh rates. The adaptive synchronization technology may be used to mitigate janks (i.e., display defects caused by missing or delayed rendering of frames) and deliver a smooth user experience.

Adaptive synchronization may work on video mode displays that are agnostic to the technology as long as the DPU supports it. However, when it comes to command mode displays, because the Vsync signal or its functional equivalent is provided by the displays, adaptive synchronization based on deferral of the Vsync signal and the display refresh may not be possible without the command mode displays explicitly supporting adaptive synchronization. Further, adaptive synchronization based on deferral of the Vsync signal may be associated with Vsync drift when GPU rendering delays occur. Therefore, a technique for implementing adaptive synchronization with command mode displays that are agnostic to the technology may be desirable. Eliminating Vsync drift may also be desirable.

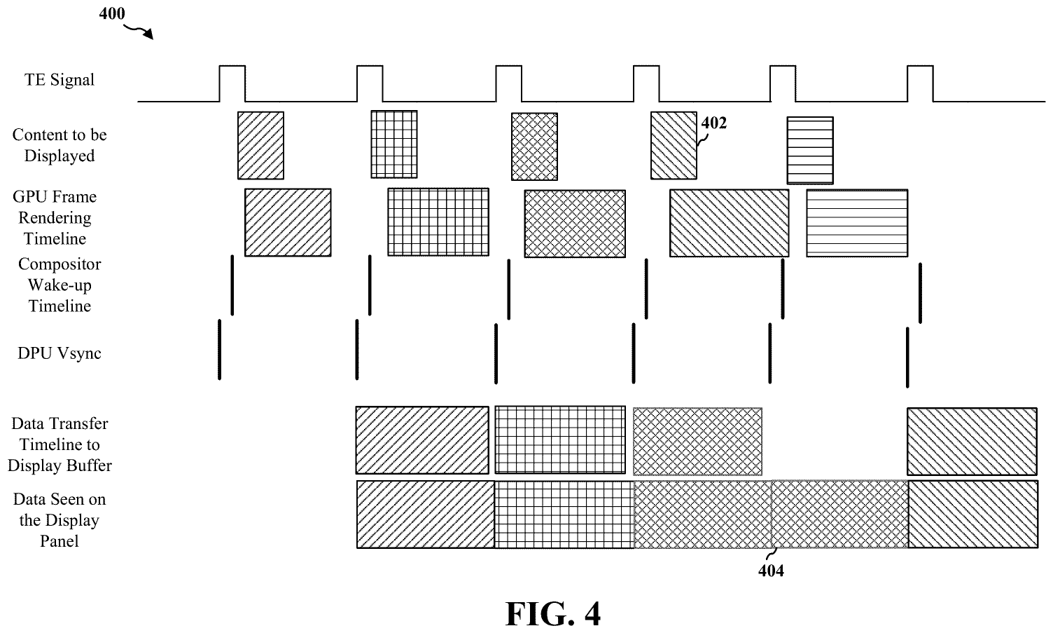

FIG. 4 is a diagram 400 illustrating display timelines associated with a command mode display without adaptive synchronization. To avoid tearing, the display (e.g., a display controller included in the display) may generate periodic TE signals to properly synchronize the writing by the DPU to the display buffer of the display with display refresh. Tearing may be exhibited as visual artifacts of two or more frames (e.g., a partial old frame and a partial new frame) within a single screen draw. To avoid tearing, display buffer locations may not be read from and written to at the same time or out of order. A TE signal may be generated once the read pointer (which may point to the display buffer location that is being read from by the display controller for content displaying) reaches a specific location of the screen such as the end (bottom) of the frame or near the end (bottom) of the frame. The TE signal may be sent from the display to the DPU, and may trigger the write pointer (which may point to the display buffer location that is written to) to begin writing on the frame. Therefore, the likelihood that display buffer locations are read from and written to at the same time or out of order may be significantly reduced. Therefore, the DPU may synchronize the transmission of display data to the command mode display based on the TE signal. Because the TE signal may be functionally similar or equivalent to the Vsync signal generated by the DPU for video mode displays, the TE signal may also be referred to hereinafter as the display/panel Vsync signal.

As illustrated in FIG. 4, the DPU may transfer display data to the display memory at rising edges of the TE signal (which may be referred to hereinafter simply as the TE signals). Accordingly, the DPU Vsync signals may be aligned with the rising edges of the TE signal. Because the display memory read operation (e.g., by the display controller for displaying content) closely follows the display memory write operation by the DPU, there may be little or no margin to accommodate GPU rendering delays and/or DPU composition delays. For example, the GPU rendering associated with the frame 402 may not be completed on time (e.g., ahead of the TE signal rising edge/DPU Vsync signal), which may be due, e.g., to late GPU fence signaling. Because the TE signal may not be deferred and the DPU may not transmit the data for the frame to the display buffer in time for the display refresh, a frame miss or jank may occur on the display panel at 404 as a result.

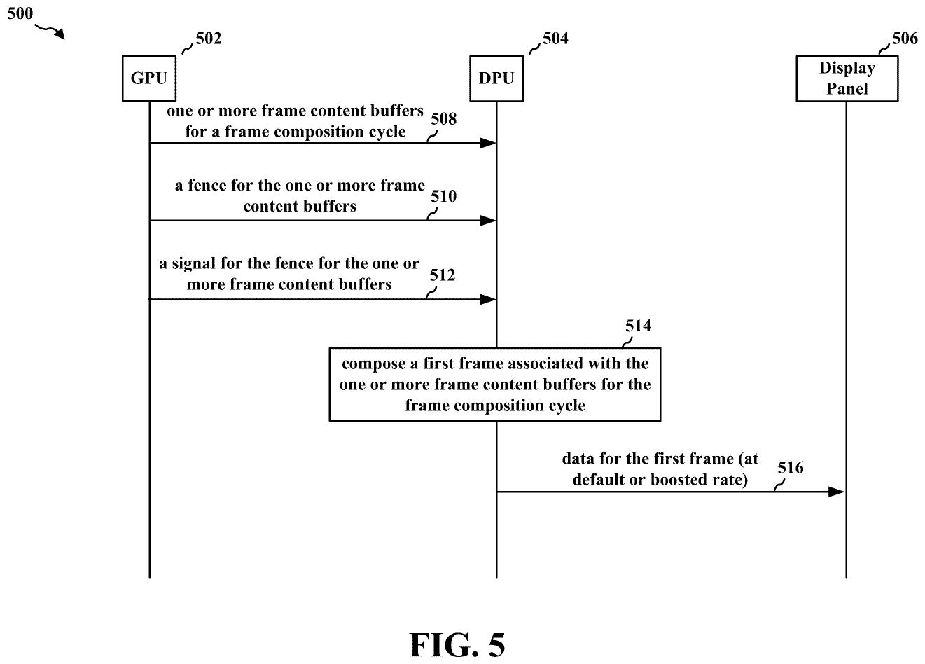

FIG. 5 is a call flow diagram 500 illustrating example communications between a GPU 502, a DPU 504, and a display 506 in accordance with one or more techniques of this disclosure. The GPU 502 may correspond to the GPU 210 in FIG. 2. The DPU 504 may correspond to the display processor 127 in FIGS. 1 and 2. The display 506 may correspond to display(s) 131 in FIGS. 1 and 2, and may be a command mode display. At 508, the DPU 504 may obtain, from a GPU 502, one or more frame content buffers for a frame composition cycle. A fence for a frame content buffer may correspond to the frame content buffer being rendered at the GPU. The frame content buffer may be a memory buffer (e.g., in the RAM) containing the data representing the pixels for the corresponding application. A fence for the frame content buffer may be an entity that conveys whether the corresponding frame content buffer is ready to be consumed (read from) or produced (written into) by the corresponding hardware (e.g., the DPU, the GPU, etc.). The fence may have one of two states: a signaled state and an un-signaled state. A sequence of events may take place as follows where the fence is utilized. First, an application may request that the GPU render the content of the application into a frame content buffer. Next, the frame content buffer may be queued (along with a corresponding fence provided by the GPU software driver to the display software driver to be consumed by the DPU hardware and displayed on the display panel. Next, the DPU may read the pixels from the frame content buffer and may send the pixels to the display panel. However, the DPU software driver may need to ensure that the GPU hardware has finished rendering the content of the application into the frame content buffer (i.e., the write by the GPU to the buffer is completed) before programming the DPU hardware to read the content of the buffer and send the buffer content to the display panel. Accordingly, thereafter, to ensure that the GPU hardware has finished rendering the content, the DPU driver may wait for the fence to be signaled by the GPU driver before the DPU driver may process the content to be displayed on the display panel. The fence may also be used in the reverse scenario. In other words, if the GPU hardware needs to reuse the same buffer to write new content, the GPU driver may wait for the corresponding fence (which may be provided by the DPU driver in this scenario) to be signaled by the DPU driver. This may ensure that the DPU hardware has finished reading from the buffer.

At 510, the DPU 504 may obtain, from the GPU 502, a fence for the one or more frame content buffers. The fence for the one or more frame content buffers may correspond to the frame content buffer being rendered. At 512, the DPU 504 may receive, from the GPU 502, a signal for the fence (e.g., an indication of the state of the fence) for the one or more frame content buffers. The signal for the fences for the frame content buffers may correspond to the frame associated with the fences being finished rendering at the GPU. At 514, the DPU 504 may compose, based on the signal for the fence for the one or more frame content buffers, a first frame associated with the one or more frame content buffers for the frame composition cycle. In one configuration, each frame composition cycle may correspond to one frame. In another configuration, each frame composition cycle may correspond to more than one frame. At 516, the DPU 504 may transfer, to a display 506 memory, data for the first frame associated with a first synchronization signal (e.g., a DPU Vsync signal). The data for the first frame may be transferred at a default transfer rate or a boosted transfer rate based on whether the data for the first frame is ready for the transfer prior to or at the first synchronization signal. The first synchronization signal may precede a corresponding TE signal associated with the display by a predetermined offset (e.g., 2 ms, 3 ms, etc.). As will be explained below, the DPU 504 may use this offset to wait for GPU fence signals, and may begin to transfer the data any time before the corresponding TE signal. If there is a GPU rendering delay, the DPU 504 may increase the clock frequency and therefore the transfer bandwidth for the transfer of the data to the display memory.

If the GPU 502 completes the rendering associated with the first frame on time, the DPU 504 may transmit the data for the first frame to the display 506 memory at the default transfer rate. In particular, the rendering time at the GPU 502 may be less than or equal to a rendering time threshold. The DPU 504 may receive the signal for the fence for the one or more frame content buffers on time. Accordingly, the DPU 504 may compose the first frame, and the data for the first frame may be ready for the transfer prior to or at the first synchronization signal (i.e., the DPU 504 Vsync signal corresponding to the first frame).

On the other hand, if the GPU 502 does not complete the rendering associated with the first frame on time, the DPU 504 may transmit the data for the first frame to the display memory at the boosted transfer rate. In particular, the rendering time at the GPU 502 may be greater than the rendering time threshold. The DPU 504 may not receive the signal for the fence for the one or more frame content buffers on time. In other words, the reception at the DPU 504 of the signal for the fence for the one or more frame content buffers may be delayed. The DPU 504 may compose the first frame. However, because the reception at the DPU 504 of the signal for the fence is delayed, the data for the first frame may not be ready for the transfer prior to or at the first synchronization signal. To compensate for the delay, the DPU 504 may transmit the data for the first frame to the display 506 memory at the boosted transfer rate. This may be accomplished by increasing the clock frequency of the DPU 504 and the transfer above the default clock frequency, thereby increasing the bandwidth for the transfer. In one configuration, in response to the reception at the DPU 504 of the signal for the fence being delayed, the DPU 504 may compose the first frame at a boosted clock frequency. This may help to reduce the total delay by reducing the composition time.

In any event, the transfer of the data for the first frame may be started before or at the corresponding TE signal. Therefore, the DPU 504 may tolerate GPU rendering delays or DPU composition delays up to the offset margin with no frame being missed.

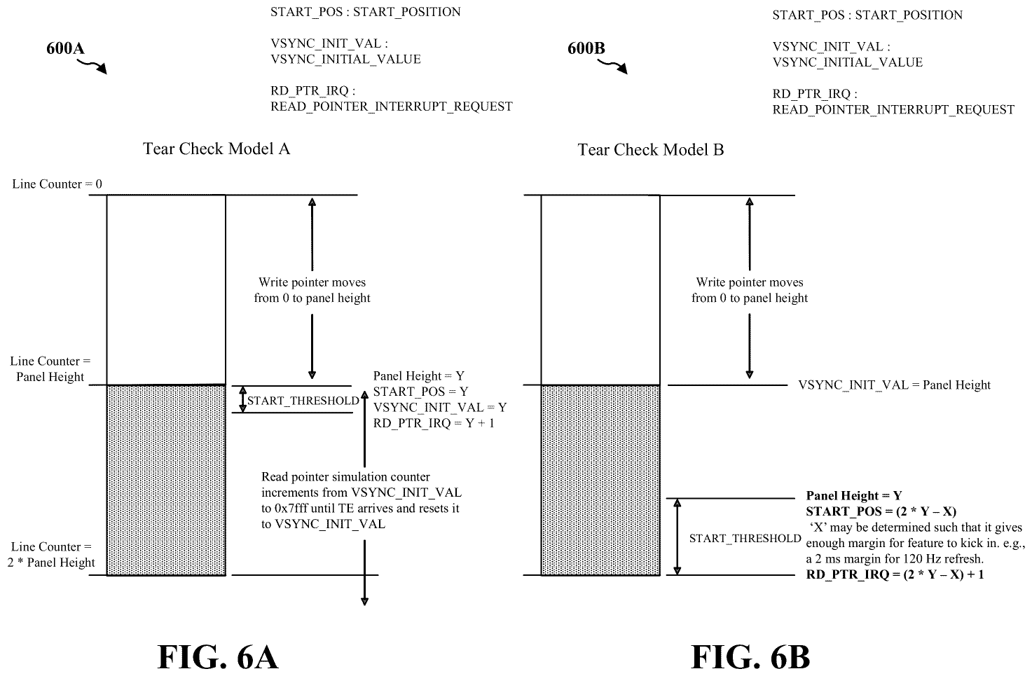

FIGS. 6A and 6B are diagrams 600A and 600B illustrating tear check models. In order to ensure that the panel write may be non-overlapping with the panel read simulation in the DPU, a tear check model may be programmed to have separate ranges for read and write pointers. In particular, the panel write pointer may be associated with the range of [0, panel height] (e.g., a line count number range from 0 to the panel height (vertical resolution), inclusive), and the panel read simulation pointer may be associated with the range of [panel height, 2× panel height] (e.g., a line count number range from the vertical resolution to two times the vertical resolution, inclusive). The pixel data transfer to the panel may start when the panel read simulation pointer is in the range of [START_POS, START_POS+START_THRESHOLD]. Further, “VSYNC_INIT_VAL” may be the line count number to which the panel read simulation pointer resets on receiving the TE signal from the panel. Moreover, “RD_PTR_IRQ” may be the line count number upon reaching which by the read simulation pointer the DPU may generate an interrupt (e.g., a DPU Vsync), which may be used as a reference for compositor wake ups illustrated in FIGS. 3 and 4. FIG. 6A illustrates a tear check model associated with a command mode display without adaptive synchronization. The “START THRESHOLD” range may indicate the starting time for the transfer of the data associated with a frame. The write pointer may move from 0 to the line counter number corresponding to the panel height (vertical resolution). The read simulation pointer may increment from “START_POS” (which may be equal to the line counter number corresponding to the panel height (vertical resolution)) to the line counter number corresponding to twice the panel height (vertical resolution) (e.g., 0x7FFF) until the TE signal arrives and resets the read pointer to “VSYNC_INIT_VAL” (which may be equal to the line counter number corresponding to the panel height (vertical resolution)).

FIG. 6B illustrates a tear check model associated with a command mode display in accordance with one or more techniques of this disclosure. The “START THRESHOLD” range may indicate the starting time for the transfer of the data associated with a frame. The write pointer may move from 0 to the line counter number corresponding to the panel height (vertical resolution). The read pointer may increment from “START_POS” (which may be calculated by subtracting X from the line counter number corresponding to twice the panel height (vertical resolution)), where the value of X may be selected such that a margin (e.g., a 2 ms margin for the 120 Hz refresh rate) is provided to accommodate potential GPU rendering delays. If the GPU fences do not signal before “START_POS,” the DPU may increase the clock speed to increase the bandwidth for the transfer of the data to the display memory in order to compensate for the lost time associated with the delayed start of the data transfer.

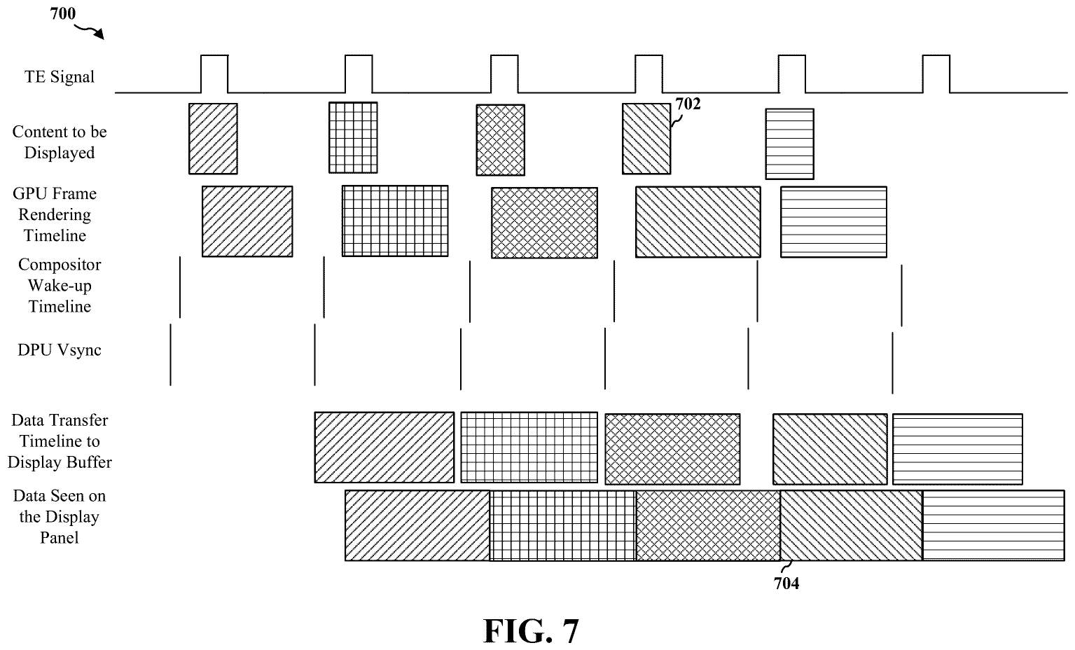

FIG. 7 is a diagram 700 illustrating display timelines associated with a command mode display with DPU driven adaptive synchronization in accordance with one or more techniques of this disclosure. Compared to the timelines illustrated in FIG. 4, in FIG. 7, the compositor wake-up timeline and the DPU Vsync signals may be advanced by an offset relative to the TE signal to provide a margin to accommodate potential GPU rendering delays. For example, similar to the situation associated with the frame 402 in FIG. 4, the GPU rendering associated with the frame 702 may not be completed on time (e.g., ahead of the corresponding DPU Vsync signal), which may be due, e.g., to late GPU fence signaling. Although the data for the frame 702 may not be ready for the transfer to the display memory prior to the corresponding DPU Vsync signal, because the DPU Vsync signal precedes the corresponding TE signal by an offset, the data for the frame 702 may become ready for the transfer prior to the corresponding TE signal, due to the margin provided by the offset. The DPU may start the transfer before or at the corresponding TE signal, and may increase the clock frequency and the bandwidth for the transfer such that the data for the frame 702 may be transferred to the display memory at a boosted rate in order to compensate for the delayed start of the data transfer. Therefore, unlike the scenario illustrated in FIG. 4, there may be no frame miss associated with the frame 702 on the display panel at 704, even though there is a similar GPU rendering delay. In other words, janks may be avoided.

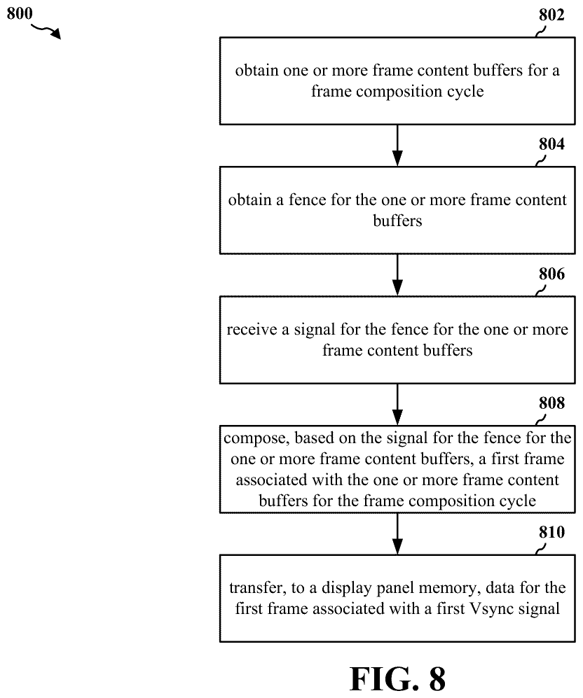

FIG. 8 is a flowchart 800 of an example method of display processing in accordance with one or more techniques of this disclosure. The method may be performed by an apparatus, such as an apparatus for display processing, a DPU or other display processor, a wireless communication device, and the like, as used in connection with the aspects of FIGS. 5-7.

At 802, the apparatus may obtain one or more frame content buffers for a frame composition cycle. For example, referring to FIG. 5, at 508, the DPU 504 may obtain one or more frame content buffers for a frame composition cycle. Further, display processor 127 in FIG. 1 may perform step 802.

At 804, the apparatus may obtain a fence for the one or more frame content buffers. The fence for the one or more frame content buffers may correspond to the frame content buffer being rendered at the GPU. For example, referring to FIG. 5, at 510, the DPU 504 may obtain a fence for the one or more frame content buffers. Further, display processor 127 in FIG. 1 may perform step 804.

At 806, the apparatus may receive a signal for the fence for the one or more frame content buffers. The signal for the fence for the one or more frame content buffers may correspond to a frame associated with the fence being finished rendering. For example, referring to FIG. 5, at 512, the DPU 504 may receive a signal for the fence for each of the one or more frame content buffers. Further, display processor 127 in FIG. 1 may perform step 806.

At 808, the apparatus may compose, based on the signal for the fence for the one or more frame content buffers, a first frame associated with the one or more frame content buffers for the frame composition cycle. For example, referring to FIG. 5, at 514, the DPU 504 may compose, based on the signal for the fence for the one or more frame content buffers, a first frame associated with the one or more frame content buffers for the frame composition cycle. Further, display processor 127 in FIG. 1 may perform step 808.

At 810, the apparatus may transfer, to a display memory of a display, data for the first frame associated with a first synchronization signal. The data for the first frame may be transferred at a default transfer rate or a boosted transfer rate based on whether or not the data for the first frame is ready for the transfer prior to or at the first synchronization signal. For example, referring to FIG. 5, at 516, the DPU 504 may transfer, to a display 506 memory, data for the first frame associated with a first synchronization signal. Further, display processor 127 in FIG. 1 may perform step 810.

In one configuration, if the data for the first frame is ready for the transfer prior to or at the first synchronization signal, the data for the first frame may be transferred at the default transfer rate.

In one configuration, the data for the first frame being ready for the transfer prior to or at the first synchronization signal may correspond to the reception of the signal for the fence for the one or more frame content buffers being on-time from the GPU.

In one configuration, the on-time reception of the signal for the fence for the one or more frame content buffers may be associated with a rendering time at the GPU that is less than or equal to a rendering time threshold.

In one configuration, if the data for the first frame is not ready for the transfer prior to or at the first synchronization signal, the data for the first frame may be transferred at the boosted transfer rate.

In one configuration, the data for the first frame not being ready for the transfer prior to or at the first synchronization signal may correspond to the reception of the signal for the fence for the one or more frame content buffers being delayed from the GPU.

In one configuration, the delayed reception of the signal for the fence for the one or more frame content buffers may be associated with a rendering time at the GPU that is greater than a rendering time threshold.

In one configuration, referring back to FIG. 5, the default transfer rate may be associated with a first clock frequency at a DPU 504. The boosted transfer rate may be associated with a second clock frequency at the DPU 504. The second clock frequency may be higher than the first clock frequency.

In one configuration, the first Vsync signal may precede a corresponding TE signal associated with the display by a predetermined offset.

In one configuration, the transfer of the data for the first frame may be started before or at the corresponding TE signal.

In one configuration, the display may be a command mode display.

In one configuration, referring back to FIG. 5, the one or more frame content buffers may be obtained from the GPU 502. the fence for the one or more frame content buffers may be obtained from the GPU 502. The signal for the fence for the one or more content buffers may be received from the GPU 502.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for obtaining one or more frame content buffers for a frame composition cycle. The apparatus may further include means for obtaining a fence for the one or more frame content buffers. The fence for the one or more frame content buffers may correspond to the frame content buffer being rendered. The apparatus may further include means for receiving a signal for the fence for the one or more frame content buffers. The signal for the fence for the one or more frame content buffers may correspond to a frame associated with the fence being finished rendering. The apparatus may further include means for composing, based on the signal for the fence for the one or more frame content buffers, a first frame associated with the one or more frame content buffers for the frame composition cycle. The apparatus may further include means for transferring, to a display memory, data for the first frame associated with a first synchronization signal. The data for the first frame may be transferred at a default transfer rate or a boosted transfer rate based on whether or not the data for the first frame is ready for the transfer prior to or at the first synchronization signal.

In one configuration, if the data for the first frame is ready for the transfer prior to or at the first synchronization signal, the data for the first frame may be transferred at the default transfer rate. In one configuration, the data for the first frame being ready for the transfer prior to or at the first synchronization signal may correspond to the reception of the signal for the fence for the one or more frame content buffers being on-time. In one configuration, the on-time reception of the signal for the fence for the one or more frame content buffers may be associated with a rendering time at a GPU that is less than or equal to a rendering time threshold. In one configuration, if the data for the first frame is not ready for the transfer prior to or at the first synchronization signal, the data for the first frame may be transferred at the boosted transfer rate. In one configuration, the data for the first frame not being ready for the transfer prior to or at the first synchronization signal may correspond to the reception of the signal for the fence for the one or more frame content buffers being delayed. In one configuration, the delayed reception of the signal for the fence for the one or more frame content buffers may be associated with a rendering time at the GPU that is greater than a rendering time threshold. In one configuration, the default transfer rate may be associated with a first clock frequency at a DPU. The boosted transfer rate may be associated with a second clock frequency at the DPU. The second clock frequency may be higher than the first clock frequency. In one configuration, the first synchronization signal may precede a corresponding TE signal associated with the display by a predetermined offset. In one configuration, the transfer of the data for the first frame may be started before or at the corresponding TE signal. In one configuration, the display may be a command mode display. In one configuration, the one or more frame content buffers may be obtained from a GPU. The fence for the one or more frame content buffers may be obtained from the GPU. The signal for the fence for the one or more content buffers may be received from the GPU.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim clement is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may comprise RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for display processing including at least one processor coupled to a memory and configured to obtain one or more frame content buffers for a frame composition cycle; obtain a fence for the one or more frame content buffers, the fence for the one or more frame content buffers corresponding to the frame content buffer being rendered; receive a signal for the fence for the one or more frame content buffers, the signal for the fence for the one or more frame content buffers corresponding to a frame associated with the fence being finished rendering; compose, based on the signal for the fence for the one or more frame content buffers, a first frame associated with the one or more frame content buffers for the frame composition cycle; and transfer, to a display memory of a display, data for the first frame associated with a first synchronization signal, the data for the first frame being transferred at a default transfer rate or a boosted transfer rate based on whether or not the data for the first frame is ready for the transfer prior to or at the first synchronization signal.

Aspect 2 may be combined with aspect 1 and includes that if the data for the first frame is ready for the transfer prior to or at the first synchronization signal, the data for the first frame is transferred at the default transfer rate.

Aspect 3 may be combined with aspect 2 and includes that the data for the first frame being ready for the transfer prior to or at the first synchronization signal corresponds to the reception of the signal for the fence for the one or more frame content buffers being on-time.

Aspect 4 may be combined with aspect 3 and includes that the on-time reception of the signal for the fence for the one or more frame content buffers is associated with a rendering time at a GPU that is less than or equal to a rendering time threshold.

Aspect 5 may be combined with aspect 1 and includes that if the data for the first frame is not ready for the transfer prior to or at the first synchronization signal, the data for the first frame is transferred at the boosted transfer rate.

Aspect 6 may be combined with aspect 5 and includes that the data for the first frame not being ready for the transfer prior to or at the first synchronization signal corresponds to the reception of the signal for the fence for the one or more frame content buffers being delayed.

Aspect 7 may be combined with aspect 6 and includes that the delayed reception of the signal for the fence for the one or more frame content buffers is associated with a rendering time at a GPU that is greater than a rendering time threshold.

Aspect 8 may be combined with any of aspects 1-7 and includes that the default transfer rate is associated with a first clock frequency at a DPU, and the boosted transfer rate is associated with a second clock frequency at the DPU, the second clock frequency being higher than the first clock frequency.

Aspect 9 may be combined with any of aspects 1-8 and includes that the first synchronization signal precedes a corresponding TE signal associated with the display by a predetermined offset.

Aspect 10 may be combined with aspect 9 and includes that the transfer of the data for the first frame is started before or at the corresponding TE signal.

Aspect 11 may be combined with any of aspects 1-10 and includes that the display is a command mode display.

Aspect 12 may be combined with any of aspects 1-11 and includes that the one or more frame content buffers are obtained from a GPU, the fence for the one or more frame content buffers is obtained from the GPU, and the signal for the fence for the one or more content buffers is received from the GPU.

Aspect 13 may be combined with any of aspects 1-12 and includes that the apparatus is a wireless communication device.

Aspect 14 is a method for display processing for implementing any of aspects 1-13.

Aspect 15 is an apparatus for display processing including means for implementing a method as in any of aspects 1-13.

Aspect 16 is a computer-readable medium storing computer executable code, the code when executed by at least one processor causes the at least one processor to implement a method as in any of aspects 1-13.

Various aspects have been described herein. These and other aspects are within the scope of the following claims.

What is claimed is:

1. An apparatus for display processing, comprising:
a memory; and
at least one processor coupled to the memory and configured to:
obtain one or more frame content buffers for a frame composition cycle;
obtain a fence for the one or more frame content buffers, the fence for the one or more frame content buffers corresponding to the frame content buffer being rendered;
receive a signal for the fence for the one or more frame content buffers, the signal for the fence for the one or more frame content buffers corresponding to a frame associated with the fence being finished rendering;
compose, based on the signal for the fence for the one or more frame content buffers, a first frame associated with the one or more frame content buffers for the frame composition cycle; and
transfer, to a display memory of a display, data for the first frame associated with a first synchronization signal at a default transfer rate or a boosted transfer rate based on whether the data for the first frame is ready for the transfer prior to or at the first synchronization signal.

2. The apparatus of claim 1, wherein if the data for the first frame is ready for the transfer prior to or at the first synchronization signal, the data for the first frame is transferred at the default transfer rate.

3. The apparatus of claim 2, wherein the data for the first frame being ready for the transfer prior to or at the first synchronization signal corresponds to the reception of the signal for the fence for the one or more frame content buffers being on-time.

4. The apparatus of claim 3, wherein the on-time reception of the signal for the fence for the one or more frame content buffers is associated with a rendering time at a graphics processing unit (GPU) that is less than or equal to a rendering time threshold.

5. The apparatus of claim 1, wherein if the data for the first frame is not ready for the transfer prior to or at the first synchronization signal, the data for the first frame is transferred at the boosted transfer rate.

6. The apparatus of claim 5, wherein the data for the first frame not being ready for the transfer prior to or at the first synchronization signal corresponds to the reception of the signal for the fence for the one or more frame content buffers being delayed.

7. The apparatus of claim 6, wherein the delayed reception of the signal for the fence for the one or more frame content buffers is associated with a rendering time at a graphics processing unit (GPU) that is greater than a rendering time threshold.

8. The apparatus of claim 1, wherein the default transfer rate is associated with a first clock frequency at a display processing unit (DPU), and the boosted transfer rate is associated with a second clock frequency at the DPU, the second clock frequency being higher than the first clock frequency.

9. The apparatus of claim 1, wherein the first synchronization signal precedes a corresponding tear effect (TE) signal associated with the display by a predetermined offset.

10. The apparatus of claim 9, wherein the transfer of the data for the first frame is started before or at the corresponding TE signal.

11. The apparatus of claim 1, wherein the display is a command mode display.

12. The apparatus of claim 1, wherein the one or more frame content buffers are obtained from a graphics processing unit (GPU), the fence for the one or more frame content buffers is obtained from the GPU, and the signal for the fence for the one or more content buffers is received from the GPU.

13. The apparatus of claim 1, wherein the apparatus is a wireless communication device.

14. A method of display processing, comprising:
obtaining one or more frame content buffers for a frame composition cycle;
obtaining a fence for the one or more frame content buffers, the fence for the one or more frame content buffers corresponding to the frame content buffer being rendered;
receiving a signal for the fence for the one or more frame content buffers, the signal for the fence for the one or more frame content buffers corresponding to a frame associated with the fence being finished rendering composing, based on the signal for the fence for the one or more frame content buffers, a first frame associated with the one or more frame content buffers for the frame composition cycle; and
transferring, to a display memory, data for the first frame associated with a first synchronization signal, the data for the first frame being transferred at a default transfer rate or a boosted transfer rate based on whether or not the data for the first frame is ready for the transfer prior to or at the first synchronization signal.

15. The method of claim 14, wherein if the data for the first frame is ready for the transfer prior to or at the first synchronization signal, the data for the first frame is transferred at the default transfer rate.

16. The method of claim 15, wherein the data for the first frame being ready for the transfer prior to or at the first synchronization signal corresponds to the reception of the signal for the fence for the one or more frame content buffers being on-time.

17. The method of claim 16, wherein the on-time reception of the signal for the fence for the one or more frame content buffers is associated with a rendering time at a graphics processing unit (GPU) that is less than or equal to a rendering time threshold.

18. The method of claim 14, wherein if the data for the first frame is not ready for the transfer prior to or at the first synchronization signal, the data for the first frame is transferred at the boosted transfer rate.

19. The method of claim 18, wherein the data for the first frame not being ready for the transfer prior to or at the first synchronization signal corresponds to the reception of the signal for the fence for the one or more frame content buffers being delayed.

20. The method of claim 19, wherein the delayed reception of the signal for the fence for the one or more frame content buffers is associated with a rendering time at a graphics processing unit (GPU) that is greater than a rendering time threshold.

21. The method of claim 14, wherein the default transfer rate is associated with a first clock frequency at a display processing unit (DPU), and the boosted transfer rate is associated with a second clock frequency at the DPU, the second clock frequency being higher than the first clock frequency.

22. The method of claim 14, wherein the first synchronization signal precedes a corresponding tear effect (TE) signal associated with the display by a predetermined offset.

23. The method of claim 22, wherein the transfer of the data for the first frame is started before or at the corresponding TE signal.

24. The method of claim 14, wherein the one or more frame content buffers are obtained from a graphics processing unit (GPU), the fence for the one or more frame content buffers is obtained from the GPU, and the signal for the fence for the one or more content buffers is received from the GPU.

25. A non-transitory computer-readable medium storing computer executable code, the code when executed by at least one processor, causes the at least one processor to:
obtain one or more frame content buffers for a frame composition cycle;
obtain a fence for the one or more frame content buffers, the fence for the one or more frame content buffers corresponding to the frame content buffer being rendered;
receive a signal for the fence for the one or more frame content buffers, the signal for the fence for the one or more frame content buffers corresponding to a frame associated with the fence being finished rendering;
compose, based on the signal for the fence for the one or more frame content buffers, a first frame associated with the one or more frame content buffers for the frame composition cycle; and
transfer, to a display memory of a display, data for the first frame associated with a first synchronization signal, the data for the first frame being transferred at a default transfer rate or a boosted transfer rate based on whether or not the data for the first frame is ready for the transfer prior to or at the first synchronization signal.
